(19) United States
(12) Patent Application Publication
(10) Pub. No.: US 2026/0127921 A1
(43) Pub. Date: May 7, 2026

(54) AUTOMATIC NOTIFICATION FOR VEHICLE EVENTS

(71) Applicant: Rivian IP Holdings, LLC, Irvine, CA (US)

(72) Inventor: Vamsi Krishna Ravulapalli, Dublin, CA (US)

(21) Appl. No.: 19/368,831

(22) Filed: Oct. 24, 2025

Related U.S. Application Data
(60) Provisional application No. 63/717,140, filed on Nov. 6, 2024.

(51) Int. Cl. G07C 5/00; B60W 50/038; B60W 50/14; G07C 5/08; H04W 4/46

(52) U.S. Cl. CPC G07C 5/008; B60W 50/038; B60W 50/14; G07C 5/0825; H04W 4/46; B60W 2050/146; B60W 2556/45; B60W 2720/10; B60W 2756/10

(57) ABSTRACT

Systems and methods are provided for providing automatic communication from a vehicle in the event of a stop event, thermal event, or thermal propagation event. A vehicle may detect a vehicle event using one or more vehicle sensors. The vehicle may also identify an event type and an event level based on data from the one or more vehicle sensors. Then based on the identified event type and the identified event level, the vehicle may automatically transmit a message from the vehicle to an authority and output an alert to a user of the vehicle indicating a corrective action based on the event type and the event level.

### CROSS REFERENCE TO RELATED APPLICATION

This application claims priority to U.S. Provisional Patent Application No. 63/717,140, filed on Nov. 6, 2024, the entire contents of which are hereby expressly incorporated by reference herein in their entirety.

### INTRODUCTION

The present disclosure is directed to vehicle notification features and, more particularly, to providing automatic communication from a vehicle in the event of a stop event, thermal event, or thermal propagation event.

### SUMMARY

As vehicles have become increasingly complex, the number and types of issues, faults, and other safety concerns continues to increase. For example, as vehicles begin to rely more on electric propulsion systems, vehicle batteries have become more important to the operation of the vehicle. Depending on the type and severity of a vehicle event, it may be useful for emergency services to be notified. Additionally, it may be useful to alert the vehicle occupants of the vehicle event, as well as actions the vehicle occupants should perform (e.g., stay in the vehicle, exit the vehicle, turn off certain vehicle functions, etc.).

With these issues in mind, embodiments of the present disclosure provide systems, methods, and devices for automatically calling emergency services under certain circumstances. For example, if a vehicle event including a stop event, a thermal event, or a thermal propagation event is detected, the vehicle may automatically call the appropriate authorities in order to address the detected vehicle event. Additionally, the vehicle may alert the occupants of the appropriate action to take. For example, if a thermal event is detected with respect to the battery or power electronics (e.g., a fire is detected), the vehicle may automatically initiate a call to alert the fire department and may instruct the vehicle occupants to pull over to the side of the road and exit the vehicle. Alternatively, if a stop event (e.g., a critical stop event) is detected wherein the vehicle is expected to or has already lost propulsion, the vehicle may automatically initiate a call to alert the police and may instruct the vehicle occupants to move to the side of the road if possible and remain in the vehicle.

Accordingly, methods and systems are disclosed herein for enabling automatic communication to the appropriate authority based on the detection of a vehicle event. An example method includes detecting a vehicle event using one or more vehicle sensors of a vehicle. The method also includes identifying an event type and an event level based on data from the one or more vehicle sensors. And based on the identified event type and the identified event level, the method includes automatically transmitting a message from the vehicle to an authority and outputting an alert to a user of the vehicle indicating a corrective action based on the event type and the event level.

In some embodiments, the identified event type comprises a stop event, and the authority comprises a police department. The corrective action comprises instructing the vehicle to pull over to side of road and instructing any passengers to remain in the vehicle. That is, when a stop event is detected (e.g., loss of power, loss of steering, etc.), the vehicle may automatically send a message to the police, and may provide an alert inside the vehicle to instruct the vehicle occupants to pull over and remain inside the vehicle.

In some embodiments, the identified event type comprises a thermal event or a thermal propagation event, and the authority comprises a fire department. The corrective action comprises instructing the vehicle to pull over to side of road and instructing any passengers to exit the vehicle. That is, when a thermal event (e.g., thermal reading outside of a nominal range) or a thermal propagation event (e.g., propagation of a thermal event through the vehicle) is detected, the vehicle may automatically send a message to the fire department and may provide an alert inside the vehicle to instruct the vehicle occupants to pull over and exit the vehicle.

In some embodiments, the method further includes detecting, via the one or more vehicle sensors, a system fault and determining a type of system fault based on the data from the one or more vehicle sensors. In some embodiments, the type of system fault comprises a critical failure. When the system fault is a critical failure, the data from the one or more vehicle sensors may indicate a loss of vehicle power or a loss of vehicle steering. In other embodiments, the type of system fault comprises a thermal failure. Where the type of system fault is a thermal failure, the data from the one or more vehicle sensors may indicate a thermal measurement outside a nominal range. In still other embodiments, the type of system fault comprises a thermal propagation failure. In this case, the data from the one or more vehicle sensors may indicate a thermal propagation through the vehicle based on multiple spaced apart sensor measurements being outside of their respective nominal ranges.

In some embodiments, the message from the vehicle to the authority comprises information corresponding to the identified event type, the event level, and a location of the vehicle. Automatically transmitting the message from the vehicle to an authority may further comprise generating the message using a telematics control module (TCM) or experience management module (XMM) of the vehicle; and establishing a connection from the TCM or XMM of the vehicle to the authority via a public safety answering point (PSAP).

In some embodiments, outputting the alert indicating the corrective action comprises providing the alert via a vehicle display. The method then further includes, based on determining that the identified event level is above a level threshold, automatically establishing a communication channel between the authority and a mobile phone of a passenger of the vehicle.

In some embodiments, the method may further include, based on the identified event type and the identified event level, activating a reduced function mode, wherein the reduced function mode comprises one or more of a reduced maximum allowable vehicle speed or a reduced set of available vehicle functions.

### BRIEF DESCRIPTION OF THE DRAWINGS

The above and other objects and advantages of the present disclosure will be apparent upon consideration of the following detailed description, taken in conjunction with the accompanying drawings, in which like reference characters refer to like parts throughout, and in which:

FIG. 1 shows a block diagram of components of a system of a vehicle for providing automatic communication, in accordance with some embodiments of the present disclosure;

FIG. 2 shows a sequence diagram for performing automatic communication by a vehicle, in accordance with some embodiments of the present disclosure; and

FIG. 3 shows a flowchart of an illustrative process for performing automatic communication by a vehicle when a vehicle event is detected, in accordance with some embodiments of the present disclosure.

### DETAILED DESCRIPTION

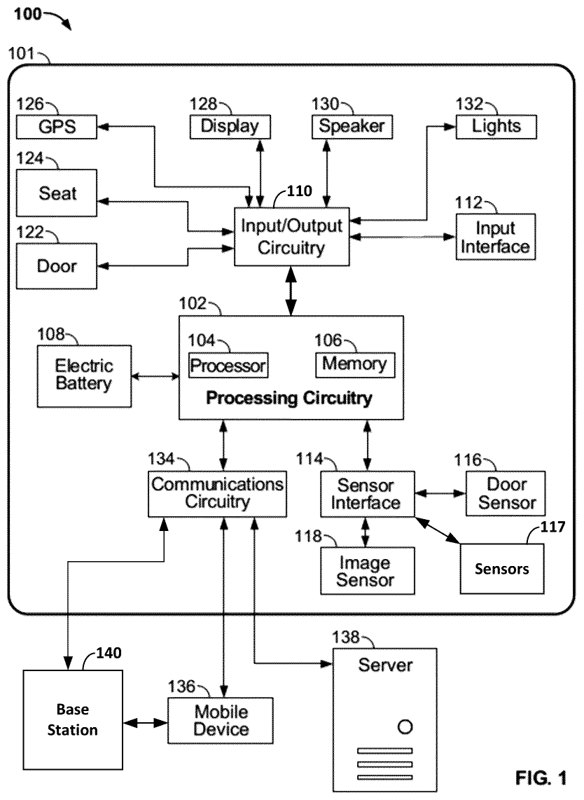

FIG. 1 shows a block diagram of components of a system 100 of vehicle 101 for providing automatic communication based on detecting a vehicle event (e.g., a stop event, a thermal event, or a thermal propagation event), in accordance with some embodiments of the present disclosure. Vehicle 101 may be a car (e.g., a coupe, a sedan, a truck, an SUV, a bus), a motorcycle, an aircraft (e.g., a drone), a watercraft (e.g., a boat), or any other type of vehicle. Vehicle 101 may be an electric vehicle, internal combustion engine vehicle, hybrid vehicle, or any other type of vehicle.

Vehicle 101 may comprise processing circuitry 102, which may comprise processor 104 and memory 106. Processor 104 may comprise a hardware processor, a software processor (e.g., a processor emulated using a virtual machine), or any combination thereof. In some embodiments, processor 104 and memory 106 in combination may be referred to as processing circuitry 102 of vehicle 101. In some embodiments, processor 104 alone may be referred to as processing circuitry 102 of vehicle 101. Memory 106 may comprise hardware elements for non-transitory storage of commands or instructions, that, when executed by processor 104, cause processor 104 to operate vehicle 101 in accordance with embodiments described above and below. Processing circuitry 102 may be communicatively connected to components of vehicle 101 via one or more wires, or via wireless connection.

Processing circuitry 102 may be communicatively connected to electric battery 108, which may be configured to provide power to one or more of the components of vehicle 101 during operation. Image sensor 118 (e.g., a camera, radar module, lidar module, or any suitable image sensor) may be communicatively coupled to processing circuitry 102 (e.g., by way of sensor interface 114) and positioned at any suitable position in an interior or exterior of vehicle 101. In some embodiments, image sensor 118 may capture images of the area around vehicle 101 in real time to identify pedestrians, other vehicles, obstacles, lane markings, etc., which may be displayed on a navigation interface. In some embodiments, image sensor 118 may capture images of destinations traveled to by vehicle 101 to identify the environment in which vehicle 101 is parked (e.g., an outdoor parking lot, an indoor parking lot, a garage, the number of nearby vehicles, etc.).

Processing circuitry 102 may also be communicatively connected to sensors 117, such as via sensor interface 114. Sensors 117 may include impact sensors, collision sensors, temperature sensors, voltage sensors, current sensors, and/or various other sensors or sensor types. As described in further detail below, sensors 117 may be configured to detect when a vehicle event or fault has occurred, such as a stop event, a thermal event, or a thermal propagation event.

Processing circuitry 102 may be communicatively connected to input interface 112 (e.g., a steering wheel, a touch screen display, buttons, knobs, a microphone or other audio capture device, etc.) via input/output circuitry 110. In some embodiments, a driver of vehicle 101 may be permitted to select certain settings in connection with the operation of vehicle 101 (e.g., passive entry settings). In some embodiments, processing circuitry 102 may be communicatively connected to Global Positioning System (GPS) system 126 of vehicle 101, where the driver may interact with the GPS system via input interface 112. GPS system 126 may be in communication with multiple satellites to ascertain the vehicle's location and provide navigation directions to processing circuitry 102. As another example, the positioning device may operate on terrestrial signals, such as cell phone signals, Wi-Fi signals, or ultra-wideband signals to determine a location of vehicle 101. The determined location may be in any suitable form such as a geographic coordinate, a street address, a nearby landmark such as an identification of the nearest charging station or a tagged location associated with the vehicle (e.g., a location of a home of the user stored in memory 106).

Processing circuitry 102 may be communicatively connected to door 122, seat 124, display 128, speaker 130, and lights 132, by way of input/output circuitry 110. In some embodiments, input/output circuitry 110 may comprise one or more domain controllers for controlling certain functions of vehicle 101. Display 128 may be located at a dashboard of vehicle 101 and/or a heads-up display on a windshield of vehicle 101. For example, an interface for GPS system 126 or an interface of an infotainment system may be generated for display, and display 128 may comprise an LCD display, an OLED display, an LED display, or any other type of display. In some embodiments, display 128 may provide a driver with a navigation interface, an entertainment interface, a backup camera interface, etc. In some embodiments, the navigation interface may generate, in real-time, a simplified rendering (e.g., animation) of objects around vehicle 101 that are captured by sensor 118 (e.g., people, other vehicles, lane markings, etc.). Speaker 130 may be located at any location within the cabin of vehicle 101, e.g., at the dashboard of vehicle 101, on an interior portion of the vehicle door. In some embodiments, speaker 130 may be located outside the cabin of vehicle 101 and provide audio that is audible outside of vehicle 101 (e.g., a personalized greeting during a welcome action of the vehicle, a door lock/unlock sound, etc.). Lights 132 may be interior or exterior lights that provide light from inside or outside of vehicle 101 (e.g., during a welcome action of the vehicle). Processing circuitry 102 may also be communicatively connected (e.g., by way of sensor interface 114) to door sensor 116 (e.g., which may sense an open door of vehicle 101).

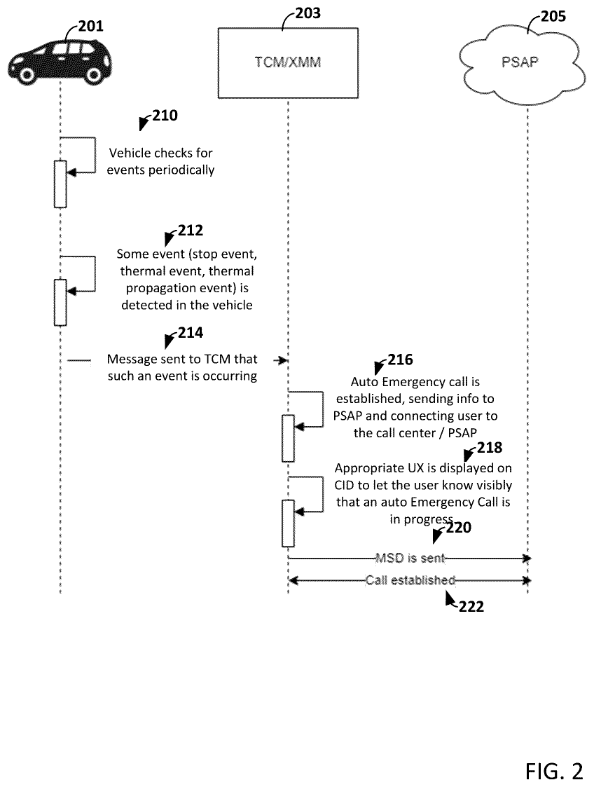

Processing circuitry 102 may be implemented as a single board, or as multiple separate boards or modules communicatively coupled to each other. In some embodiments, the processing circuitry 102 may comprise a telematics control module (TCM) and/or experience management module (XMM) (e.g., TCM/XMM 203 described with respect to FIG. 2). The TCM/XMM may interface with the display 128, speaker 130, and/or lights 132 of the vehicle 101 directly, or via input/output circuitry 110. In some embodiments, the TCM/XMM may communicate with communications circuitry 134, and/or in some embodiments the TCM/XMM may include communications circuitry 134.

In some embodiments, processing circuitry 102 may be in communication (e.g., via communications circuitry 134) with mobile device 136 (e.g., of the driver of vehicle 101). Mobile device 136 may be, for example, a smartphone, tablet, a camera, a camera array, a laptop computer, a personal computer, a desktop computer, a smart television, a smart watch or wearable device, smart glasses, extended reality (XR) glasses, XR goggles, an XR head-mounted display (HMD), near-eye display device, or any other suitable computing device or combination thereof.

Such connection may be wired or wireless. In one example, such a connection is a two-way connection via the BLE standard (e.g., via a BLE transceiver). In some embodiments, communications circuitry 134 and/or mobile device 136 may be in communication with one or more servers 138 (e.g., over a communications network such as, for example, the Internet). Further, in some embodiments, processing circuitry 102 may be in communication with a cell tower, cell network, or base station 140 via communication circuitry 134. The base station 140 may also be in communication with mobile device 136. These connections may enable communication from the vehicle 101 to one or more other entities via the base station 140 (e.g., emergency services).

It should be appreciated that FIG. 1 only shows some of the components of vehicle 101, and it will be understood that vehicle 101 also includes other elements commonly found in vehicles (e.g., vehicles), e.g., a motor, brakes, wheels, wheel controls, turn signals, windows, doors, etc. Vehicle 101 may also include a plurality of domain controllers and a central controller for performing various vehicle functions (e.g., unlocking a door of vehicle 101 and playing an unlock sound in response to receiving an unlock command).

FIG. 2 shows a sequence diagram 200 for performing automatic communication by a vehicle, in accordance with some embodiments of the present disclosure. The sequence diagram 200 illustrates vehicle 201, a telematics control module (TCM) or experience management module (XMM) 203 (which may be internal to vehicle 201), and a public safety answering point (PSAP) 205. The vehicle 201 may include one or more sensors, and the one or more sensors and the TCM/XMM 203 may be internal to the vehicle. The PSAP 205 may be external to the vehicle. The vehicle 201 may comprise processing circuitry 102, and/or one or more of sensors 116, 117, and/or 118 described above with respect to FIG. 1. The TCM/XMM 203 may be configured to perform communication and display functionality. A TCM may comprise an embedded system of the vehicle that enables wireless connection to emergency services, cloud services, other vehicles, and infrastructure, such as via a cellular network. The TCM may collect telemetry data from the vehicle sensors, such as position, orientation, speed, connectivity quality, system health, and more. The XMM may comprise the main human machine interface and/or display driver of the vehicle. It may provide the interface to change vehicle settings and personalization, manager digital entertainment, manage navigation, and provide output alerts to the vehicle occupants.

At step 210, the vehicle 201 checks for the occurrence of a vehicle event such as a stop event (e.g., critical stop), thermal event, thermal propagation event or other vehicle event. The vehicle may check periodically such as multiple times a second, every second or couple of seconds, every minute, or at any other regular or irregular interval. In some embodiments, checking for a vehicle event may include receiving a signal, such as from a sensor (e.g., sensors 116, 117, and/or 118 of FIG. 1). In some embodiments, checking for a vehicle event may include the processing circuitry receiving a fault signal or fault message from one or more vehicle systems (e.g., power control, battery control, etc.).

A vehicle may experience a wide variety of failures, faults, or other issues. Some of these issues may fall into a low level category. For example, sensors may detect the failure of an internal light or speaker, which while possibly inconvenient to the user, may not necessarily impact the operation of the vehicle. Other issues may be more significant, such as a loss of steering or inability to continue driving the vehicle, for example. In these cases, a higher level fault may be detected. In some examples, the level (e.g., low or high) associated with a given failure, fault or other vehicle issue, may be referred to as a level of severity or significance. It should be appreciated that other terminology may be used as well or instead, referring to the importance of the detected issue with respect to vehicle operation and/or safety.

At step 212, the vehicle processing circuitry (e.g., processing circuitry 102) may detect that a vehicle event has occurred. This may also include determining the type of event that has occurred. As noted above, the event may be a low level fault, which may not require further action by the vehicle. However, if the detected event is a high level fault, such as a stop event (e.g., a critical stop event), thermal event, or thermal propagation event, the vehicle may take further actions as described herein. A stop event may refer to an event that occurs with respect to the vehicle and where it is desired for the vehicle to shut off or stop operating. For example, loss of propulsion or another significant fault. A thermal event may refer to the detection of an increase (or decrease) in temperature beyond a nominal range. For example, if a temperature sensor of the battery detects a sudden increase in temperature beyond a normal range, that may indicate a fire or thermal runaway event with respect to the battery. This type of fault is more significant and may cause damage to one or more vehicle systems or loss of vehicle control if no action is taken. A thermal propagation event may refer to the detection of increased (or decreased) temperature propagating through the vehicle from one sensor or system to another. This may also be a significant fault, which may cause damage to one or more vehicle systems or loss of vehicle control if no further action is taken.

At step 214, the processing circuitry sends a message to the TCM/XMM 203. The message may include information about which sensor(s) or vehicle systems detected a fault, the sensor readings, the affected systems, the type of fault or issue detected, the level of the detected vehicle event, and more.

At step 216, the TCM/XMM 203 may establish an automatic call to send information to the PSAP 205. The information sent may include sensor readings, the type of fault detected, the affected vehicle system(s), the vehicle location, the vehicle heading, the number of passengers in the vehicle, and various other information that may be useful to understand the context of the vehicle event. The TCM/XMM 203 may also connect the user to the call center or PSAP 205. This step may include the vehicle determining the level of event that has occurred and only determining to establish the automatic call if the event rises above a certain fault level threshold.

At step 218, the TCM/XMM 203 causes an appropriate user interface of the vehicle to display an alert to the user, to indicate that the automatic call has been initiated. The alert may be a visual alert displayed on one or more vehicle screens (e.g., the center instrument display, vehicle HUD, rear seat display, center console, etc.). In some embodiments, the alert may include flashing or turning on interior lights, activating emergency lights, or causing some other visual indicator to be activated inside or outside the vehicle. In some embodiments, the TCM/XMM 203 may cause an audible alert to be presented via one or more speakers, in addition to or instead of the visual alert. In still further embodiments, the TCM/XMM 203 may cause an alert to be presented on a user's phone or other connected device. For example, the TCM/XMM 203 may transmit an alert to a phone paired to the vehicle via Bluetooth, or to a phone or other device associated with a user of the vehicle. In some embodiments, the alert may also instruct the user as to the type of fault that has occurred, as well as any precautionary measures to take (e.g., stay in the vehicle, exit the vehicle, pull over to the side of the road, shut off one or more vehicle functions, etc.). The type of alert may depend on the type of vehicle event that was detected, such that the vehicle occupants receive specific instructions tailored to address the specific vehicle event that has occurred.

At step 220, the TCM/XMM 203 transmits the minimum set of data (MSD) to the PSAP 205. The MSD may include information such as the vehicle location, direction of travel, number of passengers with fastened seat belts, and other relevant information for use by emergency services. The MSD may also include the type of fault that occurred, as well as any sensor readings or other information that may be relevant.

At step 222, the call between the TCM 203 and the PSAP 205 is established.

It will be understood that sequence diagram 200 is merely illustrative and various modifications can be made within the scope of this disclosure. For example, steps 216-222 may be performed in any order. As another example, steps 220 and/or 222 may be included as part of step 216.

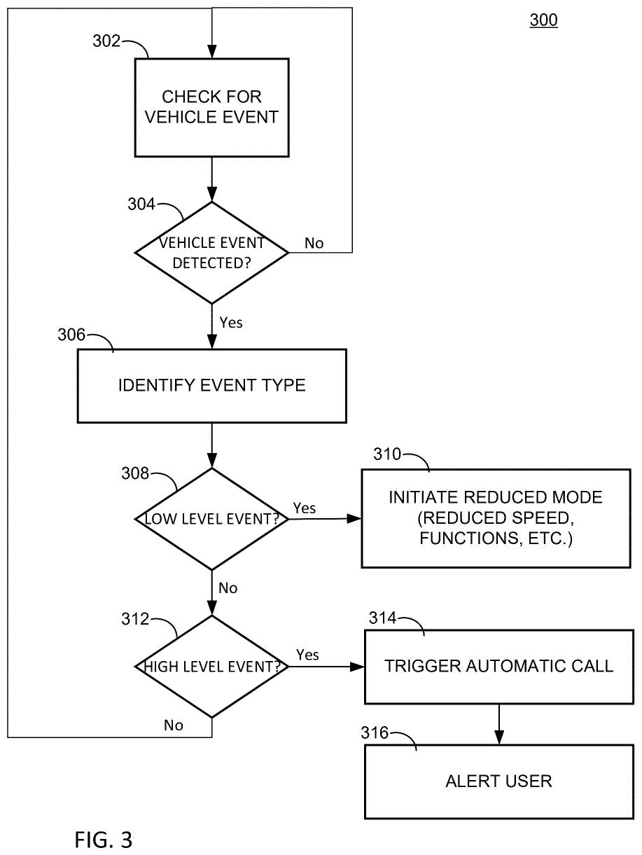

FIG. 3 shows a flowchart of an illustrative process 300 for enabling a vehicle to make an automatic call upon detecting a high level vehicle event. Process 300 may be performed at least in part by processing circuitry 102.

At 302, processing circuitry 102 checks for vehicle events. This may include the processing circuitry 102 requesting, retrieving, or receiving data from one or more sensors (e.g., sensors 116, 117, and/or 118) or vehicle modules. At 304, the processing circuitry 102 may determine whether a vehicle event has been detected (e.g., based on the sensor data and/or received fault message).

At 306, the processing circuitry 102 may identify an event type. Identifying the event type may include determining from which sensor or vehicle system the sensor data or fault message was received, identifying whether the sensor data is outside of a normal range, and/or any other suitable analysis to determine the type of event that has occurred. As a non-exhaustive list, the possible vehicle events may include a wide variety of events such as a loss of power, power electronics malfunction, or other significant system failure.

At 308, the processing circuitry 102 may determine whether the identified event is a low level event, such as a low tire pressure event, check engine light, etc. If the identified vehicle event is a low level event, the processing circuitry 102 may initiate a reduced mode at 310. The reduced mode may include one or more of reducing the vehicle speed, reducing a maximum allowable speed, reducing the number of functions available to the user, preventing one or more vehicle functions from being executed, or more.

If the processing circuitry 102 determines that the identified vehicle event is not a low level event, at 312 the processing circuitry determines whether the identified vehicle event is a high level event. A high level event may include a stop event, a thermal event, and/or a thermal propagation event. If a high level event is detected at 312, the processing circuitry 102 may execute the functions described above with respect to FIG. 2. That is, at 314, the vehicle and/or processing circuitry 102 may trigger an automatic call. The automatic call may be initiated with a PSAP, and may include transmitting various vehicle information (e.g., vehicle location, passenger information, vehicle phone number, detected vehicle event information, and more).

Additionally, at 316, the processing circuitry 102 may cause an alert to be presented to an occupant of the vehicle. The alert may include instructions to stay in the vehicle, exit the vehicle, turn on one or more vehicle functions (e.g., emergency lights), turn off one or more vehicle functions, and more. As noted above, the alert may be presented on one or more vehicle user interfaces such as display screens, and/or as an audible alert via one or more vehicle speakers. Additionally, the alert may be presented via a connected device, such as a phone associated with the vehicle. The alert may provide the occupants with an indication that the automatic call has been initiated, and/or that a connection to the PSAP has been established.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

What is claimed is:

1. A method comprising:
detecting a vehicle event using one or more vehicle sensors of a vehicle;
identifying an event type and an event level based on data from the one or more vehicle sensors; and
based on the identified event type and the identified event level:
automatically transmitting a message from the vehicle to an authority; and
outputting an alert to a user of the vehicle indicating a corrective action based on the event type and the event level.

2. The method of claim 1, wherein:
the identified event type comprises a stop event;
the authority comprises a police department; and
the corrective action comprises instructing the vehicle to pull over to side of road and instructing any passengers to remain in the vehicle.

3. The method of claim 1, wherein:
the identified event type comprises a thermal event or a thermal propagation event;
the authority comprises a fire department; and
the corrective action comprises instructing the vehicle to pull over to side of road and instructing any passengers to exit the vehicle.

4. The method of claim 1, further comprising:
detecting, via the one or more vehicle sensors, a system fault; and
determining a type of system fault based on the data from the one or more vehicle sensors.

5. The method of claim 4, wherein:
the type of system fault comprises a critical failure; and
the data from the one or more vehicle sensors indicates a loss of vehicle power or a loss of vehicle steering.

6. The method of claim 4, wherein:
the type of system fault comprises a thermal failure; and
the data from the one or more vehicle sensors indicates a thermal measurement outside a nominal range.

7. The method of claim 4, wherein:
the type of system fault comprises a thermal propagation failure; and
the data from the one or more vehicle sensors indicates a thermal propagation through the vehicle based on multiple spaced apart sensor measurements.

8. The method of claim 1, wherein the message from the vehicle to the authority comprises information corresponding to the identified event type, the event level, and a location of the vehicle, and wherein automatically transmitting the message from the vehicle to the authority further comprises:
generating the message using a telematics control module (TCM) or experience management module (XMM) of the vehicle; and
establishing a connection from the TCM or XMM of the vehicle to the authority via a public safety answering point (PSAP).

9. The method of claim 1, wherein outputting the alert indicating the corrective action comprises providing the alert via a vehicle display, the method further comprising:
based on determining that the identified event level is above a level threshold, automatically establishing a communication channel between the authority and a mobile phone of a passenger of the vehicle.

10. The method of claim 1, further comprising, based on the identified event type and the identified event level:
activating a reduced function mode, wherein the reduced function mode comprises one or more of a reduced maximum allowable vehicle speed or a reduced set of available vehicle functions.

11. A vehicle comprising:
one or more vehicle sensors configured to detect a vehicle event; and
processing circuitry configured to:
identify an event type and an event level based on data from the one or more vehicle sensors; and
based on the identified event type and the identified event level:
automatically transmit a message from the vehicle to an authority; and
output an alert to a user of the vehicle indicating a corrective action based on the event type and the event level.

12. The vehicle of claim 11, wherein:
the identified event type comprises a stop event;
the authority comprises a police department; and
the corrective action comprises instructing the vehicle to pull over to side of road and instructing any passengers to remain in the vehicle.

13. The vehicle of claim 11, wherein:
the identified event type comprises a thermal event or a thermal propagation event;
the authority comprises a fire department; and
the corrective action comprises instructing the vehicle to pull over to side of road and instructing any passengers to exit the vehicle.

14. The vehicle of claim 11, wherein the processing circuitry is further configured to:
detect, via the one or more vehicle sensors, a system fault; and
determine a type of system fault based on the data from the one or more vehicle sensors.

15. The vehicle of claim 14, wherein:
the type of system fault comprises a critical failure; and
the data from the one or more vehicle sensors indicates a loss of vehicle power or a loss of vehicle steering.

16. The vehicle of claim 14, wherein:
the type of system fault comprises a thermal failure; and
the data from the one or more vehicle sensors indicates a thermal measurement outside a nominal range.

17. The vehicle of claim 14, wherein:
the type of system fault comprises a thermal propagation failure; and
the data from the one or more vehicle sensors indicates a thermal propagation through the vehicle based on multiple spaced apart sensor measurements.

18. The vehicle of claim 11, wherein the message from the vehicle to the authority comprises information corresponding to the identified event type, the event level, and a location of the vehicle, and wherein the processing circuitry is further configured to automatically transmit the message from the vehicle to the authority by:
generating the message using a telematics control module (TCM) or experience management module (XMM) of the vehicle; and
establishing a connection from the TCM or XMM of the vehicle to the authority via a public safety answering point (PSAP).

19. The vehicle of claim 11, wherein the processing circuitry is configured to output the alert indicating the corrective action by providing the alert via a vehicle display, and wherein the processing circuitry is further configured to:
based on determining that the identified event level is above a level threshold, automatically establish a communication channel between the authority and a mobile phone of a passenger of the vehicle.

20. The vehicle of claim 11, wherein the processing circuitry is further configured to, based on the identified event type and the identified event level:
activate a reduced function mode, wherein the reduced function mode comprises one or more of a reduced maximum allowable vehicle speed or a reduced set of available vehicle functions.
